(19) United States
(12) Patent Application Publication
(10) Pub. No.: US 2024/0200214 A1
(43) Pub. Date: Jun. 20, 2024

(54) WATER ELECTROLYSIS APPARATUS

(71) Applicant: TOYOTA JIDOSHA KABUSHIKI KAISHA, Toyota-shi (JP)

(72) Inventors: Makoto Mori, Susono-shi (JP); Nobuyuki Kitamura, Yamanashi-ken (JP)

(73) Assignee: TOYOTA JIDOSHA KABUSHIKI KAISHA, Toyota-shi (JP)

(21) Appl. No.: 18/485,406

(22) Filed: Oct. 12, 2023

(30) Foreign Application Priority Data
Dec. 20, 2022 (JP) 2022-203053

(51) Int. Cl. C25B 15/033; C25B 1/04; C25B 9/77; C25B 15/08

(52) U.S. Cl. CPC C25B 15/033; C25B 1/04; C25B 9/77; C25B 15/087

(57) ABSTRACT

A device for supplying water to a water electrolysis cell and supplying a voltage to obtain hydrogen and oxygen, the device comprising: a water electrolysis stack in which a water electrolysis cell is laminated; a water supply side path having a pipe for supplying water to the water electrolysis stack; a hydrogen side path having a pipe for recovering hydrogen generated from the water electrolysis stack; and a water recirculation path having a pipe for returning water from the hydrogen side path to the water supply side path; and a conductivity meter for measuring conductivity of water flowing through the pipe, a valve for draining water from the pipe, and a controller for performing control for draining water from the valve based on a measured value of the conductivity meter, in the water supply side path and the water recirculation path.

### CROSS-REFERENCE TO RELATED APPLICATION

This application claims priority to Japanese Patent Application No. 2022-203053 filed on Dec. 20, 2022, incorporated herein by reference in its entirety.

### BACKGROUND

### 1. Technical Field

The present disclosure relates to a water electrolysis apparatus.

### 2. Description of Related Art

In a water electrolysis apparatus that generates hydrogen and oxygen by electrolyzing water, when ions are contained in water supplied to a water electrolysis cell in which water electrolysis is performed, deterioration of the water electrolysis cell may be accelerated, and therefore, it is desired to remove these ions.

Japanese Unexamined Patent Application Publication No. 2021-193207 (JP 2021-193207 A) discloses that when electrolysis of water by an electrolysis cell is stopped, oxygen in the oxygen storage portion is supplied to the water supply flow path by controlling the oxygen-side treatment portion.

### SUMMARY

In the technology of JP 2021-193207 A, since ions remain in the system, there is a possibility that an increase in conductivity occurs over time.

In view of the prior art, an object of the present disclosure is to provide a water electrolysis apparatus capable of more reliably suppressing ions from being contained in water supplied to a water electrolysis stack.

Metal pipes made from stainless steel and the like are often used for the water electrolysis apparatus. Such a metal elutes as a metal ion into the water flowing in the pipe in an oxygen atmosphere or a hydrogen atmosphere, and the conductivity of the water flowing in the pipe may increase. When water having such a high conductivity is supplied to the water electrolysis cell, there is a possibility that the water electrolysis efficiency is lowered due to deterioration of the electrode resulting from adsorption of ions to the electrode or oxidation of ions. The elution of such metal ions is particularly remarkable in a hydrogen atmosphere, and the inventors have found that the elution rate reaches four times with respect to that in an oxygen atmosphere.

The present application discloses a water electrolysis apparatus that supplies water to a water electrolysis cell and applies a voltage to obtain hydrogen and oxygen, and the water electrolysis apparatus includes: a water electrolysis stack in which the water electrolysis cells are laminated; a water supply side path including a pipe through which water is supplied to the water electrolysis stack; a hydrogen side path including a pipe through which hydrogen generated from the water electrolysis stack is recovered; and a water recirculation path including a pipe through which water from the hydrogen side path is returned to the water supply side path.

In each of the water supply side path and the water recirculation path, a conductivity meter that measures conductivity of water flowing through the pipe, a valve from which water from the pipe is drained, and a controller are provided.

The controller performs control to drain water from the valve based on a measured value of the conductivity meter.

In the water electrolysis apparatus, the controller may be configured to perform control using the conductivity meter and the valve provided in the water supply side path in an operation in which water electrolysis is not performed in the water electrolysis stack, and perform control using the conductivity meter and the valve provided in the water recirculation path in an operation in which water electrolysis is performed in the water electrolysis stack.

In the operation in which the water electrolysis is performed in the water electrolysis stack, the controller may be configured to acquire a water consumption flow rate due to the water electrolysis, calculate an accompanying water amount to the hydrogen side path, and determine an amount of the drained water based on the accompanying water amount.

According to the present disclosure, it is possible to more reliably suppress the water containing a large amount of ions from being supplied to the water electrolysis stack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration of a water electrolysis apparatus 10;

FIG. 2 is a cross-sectional view illustrating a layer structure of the water electrolysis cell 11;

FIG. 3 is a conceptual diagram illustrating a configuration of the controller 30;

FIG. 4 is a diagram for explaining a control S10 of the water electrolysis apparatus; and

FIG. 5 is a diagram for explaining a control S20 of the water electrolysis apparatus.

### DETAILED DESCRIPTION OF EMBODIMENTS

### 1. Configuration of Water Electrolysis Apparatus

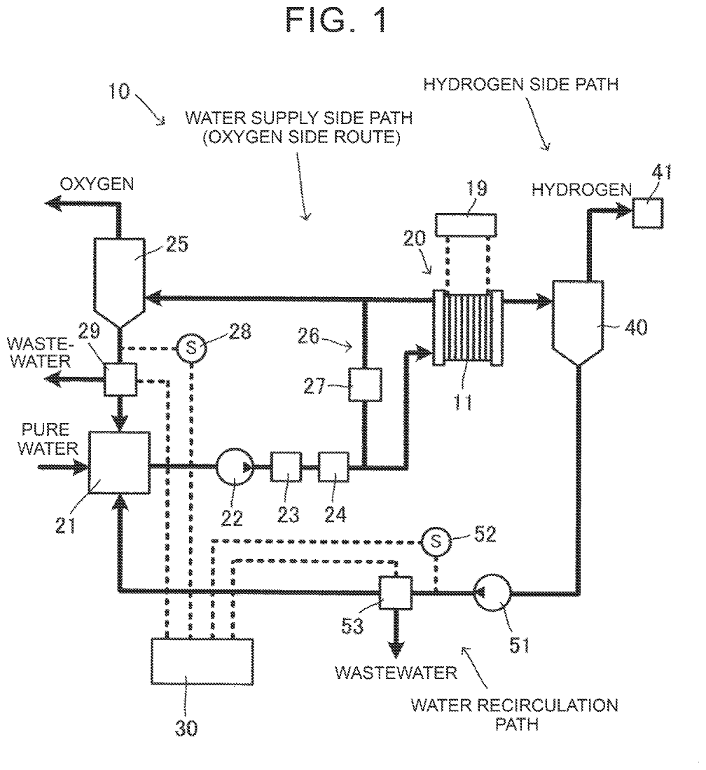

FIG. 1 conceptually illustrates a configuration of a water electrolysis apparatus 10 according to one embodiment. The basic principles and ideas regarding the generation of hydrogen and oxygen by the water electrolysis performed in the water electrolysis apparatus 10 can follow those known in the art.

In the present embodiment, the water electrolysis apparatus 10 has a water electrolysis stack 20 in which a plurality of water electrolysis cells 11 are stacked and both ends thereof are sandwiched between end plates, a water supply side path (oxygen side path) on one side with the water electrolysis stack 20 interposed therebetween, a hydrogen side path on the other side, and a water recirculation path for returning water from the hydrogen side path to the water supply side path.

In the water electrolysis apparatus 10, water is supplied to the water electrolysis cell 11 provided in the water electrolysis stack 20 from the water supply side path, and is energized by the power source 19 to decompose the water into hydrogen and oxygen. The obtained hydrogen is discharged to the hydrogen side path, recovered, and stored. Some of the water passes through the electrolysis cell 11 as the accompanying water and reaches the hydrogen side path from the water supply side path, so that the water is separated into hydrogen and water in the hydrogen side path, and the separated water is returned to the water supply side path in the water recirculation path.

Hereinafter, each configuration will be further described.

### 1.1. Water Electrolysis Stack

As described above, the water electrolysis stack 20 is configured such that a plurality of water electrolysis cells 11 are stacked and sandwiched between end plates disposed at both ends thereof.

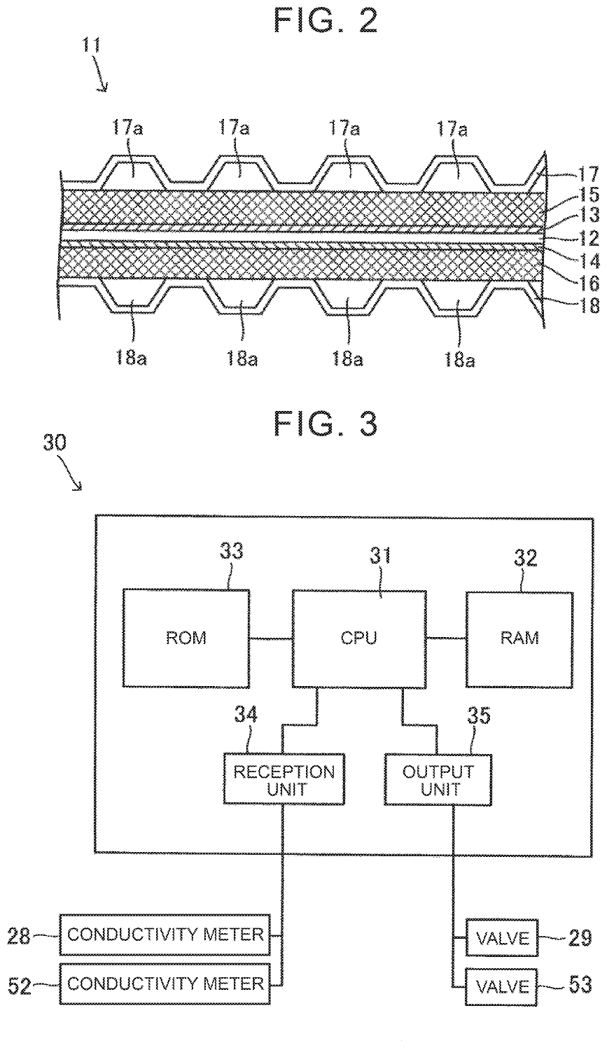

FIG. 2 shows a part of a cross section of a portion where water electrolysis is performed in one water electrolysis cell 11. As can be seen from FIG. 2, the water electrolysis cell 11 has a laminated structure including a plurality of layers. Although the layer structure is known and is not particularly limited, for example, as shown in FIG. 2, in the water electrolysis cell 11, the hydrogen electrode catalyst layer 13, the hydrogen electrode diffusion layer 15, and the hydrogen electrode separator 17 are laminated on one side of the electrolyte membrane 12, and the oxygen electrode catalyst layer 14, the oxygen electrode diffusion layer 16, and the oxygen electrode separator 18 are laminated on the other side of the electrolyte membrane 12.

The hydrogen electrode separator 17 has a corrugated shape in the cross section, and forms a groove-shaped hydrogen electrode flow path 17a with the hydrogen electrode diffusion layer 15, and the hydrogen and the accompanying water flow through the hydrogen electrode flow path 17a and are discharged to the hydrogen side path. On the other hand, the oxygen electrode separator 18 is also corrugated in the cross section and form a groove-shaped oxygen electrode flow path 18a with the oxygen electrode diffusing layer 16. Water is supplied from the water supply side path to the oxygen electrode flow path 18a, and oxygen and the remaining water are discharged from the oxygen electrode flow path 18a to the water supply side path.

A power source 19 is connected between both electrodes of the water electrolysis stack 20 via a power supply line. When a voltage is applied from the power source 19 to the water electrolysis stack 20, water electrolysis is performed in the water electrolysis cell 11. Here, the power source 19 is as known in the art, and a normal power source used for water electrolysis can be applied.

### 1.2. Water Supply Side Path (Oxygen Side Path)

The water supply side path (oxygen side path) has a path in which municipal water is passed through an ion exchanger or the like to be pure water and stored in the tank 21, and water is supplied to the water electrolysis stack 20 through the cooler 23 and the ion exchanger 24 by the pump 22. Oxygen and water leaving the water electrolysis stack 20 are returned to the gas-liquid separator 25 to separate the gas-liquid, and the gas (oxygen) is discharged and the liquid (water) is returned to the tank 21 to be used for water electrolysis again. Each of these members is connected by a pipe, and is configured to allow water and oxygen to flow in a necessary path.

In the present embodiment, the water supply side path includes a pipe 26 connecting a pipe for supplying water to the water electrolysis stack 20 and a pipe for flowing the waste water from the water electrolysis stack 20, and a valve 27. The water can be circulated through the water supply side path without supplying water to the water electrolysis stack 20 through the pipe 26. By opening the valve 27, water can flow to the pipe 26, and by closing the valve 27, the flow of water to the pipe 26 is restricted.

Further, in the present embodiment, the pipe between the gas-liquid separator 25 and the tank 21 in the water supply side path, a conductivity meter 28 for measuring the conductivity of the water flowing in the pipe, and a valve 29.

Conductivity meter 28 can be used as known, from the viewpoint of obtaining conductivity which is one piece of the information for adjusting the opening and closing of the valve 29 as described later, communicably connected to the controller 30, it is configured to be able to transmit the obtained conductivity information to the controller 30.

The valve 29 is configured to drain the water flowing through the pipe from the water supply side path by opening the valve. When the valve is closed, the drainage is regulated so that water flows from the gas-liquid separator 25 to the tank 21. The form of the valve 29 is not particularly limited, but may be a solenoid valve so that the opening and closing thereof can be controlled by the controller 30.

Further, a controller 30 is provided in the water supply side path. The controller 30 is a controller that controls the water electrolysis apparatus 10 of the present embodiment. More specifically, the present embodiment is a controller that controls the opening and closing of the valve 29 based on at least conductivity information from the conductivity meter 28. However, it is not necessary to be a controller only for this purpose, and other functions for controlling the water electrolysis apparatus 10 can be provided. The embodiment of the controller 30 is not particularly limited, but may typically be configured by a computer. FIG. 3 conceptually illustrates a configuration example of the computer 30 as the controller 30.

The computer 30 includes a CPU (Central Processing Unit) 31 that is a processor, a RAM (Random Access Memory) 32 that functions as a working area, a ROM (Read-Only Memory) 33 as a storage medium, a reception unit 34 that is an interface that receives information regardless of whether it is wired or wireless to the computer 30, and an output unit 35 that is an interface that transmits information regardless of whether it is wired or wireless from the computer 30 to the outside.

A conductivity meter 28 is communicatively connected to the reception unit 34, and is configured to receive conductivity information by a signal. On the other hand, a valve 29 is communicatively connected to the output unit 35 so that the opening and closing of the valve 29 can be controlled.

The computer 30 stores a computer program for executing each process for control performed by the water electrolysis apparatus 10 of the present embodiment as a specific command. In the computer 30, a CPU 31, RAM 32 and a ROM 33 as hardware resources and a computer program cooperate with each other. Specifically, CPU 31 executes the computer program recorded in ROM 33 in a RAM 32 functioning as a working area on the basis of the conductivity data of the conductivity meter 28 acquired via the reception unit 34 and the like, thereby realizing a function. The data acquired or generated by CPU 31 is stored in RAM 32. Based on the obtained result, a command is transmitted to the valve 29 via the output unit 35 as necessary.

Details of the control by the water electrolysis apparatus 10 will be described later.

### 1.3. Hydrogen Side Pathway

In the hydrogen side path, as can be seen from FIG. 1, the hydrogen and the accompanying water leaving the water electrolysis stack 20 are recovered in the gas-liquid separator 40, the gas-liquid is separated, and the gas (hydrogen) is stored in the hydrogen tank 41 via a dehumidifier or the like. On the other hand, the water (accompanying water) separated by the gas-liquid separator 40 is returned to the tank 21 of the water supply side path via the water recirculation path. These members are also connected by pipes, and are configured to allow water and hydrogen to flow in a necessary path.

### 1.4. Water Recirculation Path

In the water recirculation path, the water separated by the gas-liquid separator 40 in the hydrogen side path is sent to the tank 21 in the water supply side path by the pump 51. A pump 51, a conductivity meter 52, and a valve 53 are disposed in the water recirculation path, and these members are connected by pipes so that water can flow in a necessary path.

The conductivity meter 52 may be a known one, but is communicatively connected to the controller 30 from the viewpoint of obtaining conductivity, which is one piece of the information for operating the valve 53, as will be described later, and is configured so that the obtained conductivity information can be transmitted to the controller 30.

The valve 53 is configured to drain the water flowing through the pipe from the water recirculation path by opening the valve. When the valve is closed, the drainage is regulated so that water flows from the gas-liquid separator 40 to the tank 21. Although the form of the valve 53 is not particularly limited, it may be a solenoid valve so that the opening and closing thereof can be controlled by the controller 30. Alternatively, the valve 53 may be a regulating valve so that the amount of drainage can be regulated. The controller 30 is configured to control the operation of the valve when the valve is a regulating valve.

In this way, a controller is also provided in the water recirculation path, but it is possible to consider the same as the controller 30 described above, and it is possible to also use the controller 30. Therefore, as shown in FIG. 3, the conductivity meter 52 is communicably connected to the reception unit 34 of the controller 30, and the valve 53 is communicably connected to the output unit 35 of the controller 30.

### 2. Control of Water Electrolysis Apparatus

As described above, in the water electrolysis apparatus, ions may be contained in the water supplied to the water electrolysis stack, and when such water is supplied to the water electrolysis cell, a problem may occur. Therefore, in the present embodiment, control is performed to prevent water containing a large amount of ions from being supplied to the water electrolysis stack, and the occurrence of a defect is suppressed more reliably.

The water electrolysis apparatus 10 includes several preparation steps from a stop state to a normal water electrolysis operation, and specifically includes a piping flushing step, a stack flushing step, and a stack aging step. In the present embodiment, control by the controller 30 is performed for each of the preparation steps and the normal operation of the water electrolysis. Describe below

### 2.1. Pipe Flushing

The pipe flushing is a preparation step performed in a state in which no voltage is applied to the water electrolysis stack 20, and is a step of flushing the water supply side path.

In the pipe flushing, water is circulated by the pump 22 in a state where the valve 27 is opened. Therefore, the water circulates in the path of the pump 22, the cooler 23, the ion exchanger 24, the valve 27 (the pipe 26), the gas-liquid separator 25, and the tank 21, and the water does not circulate in the water electrolysis stack 20.

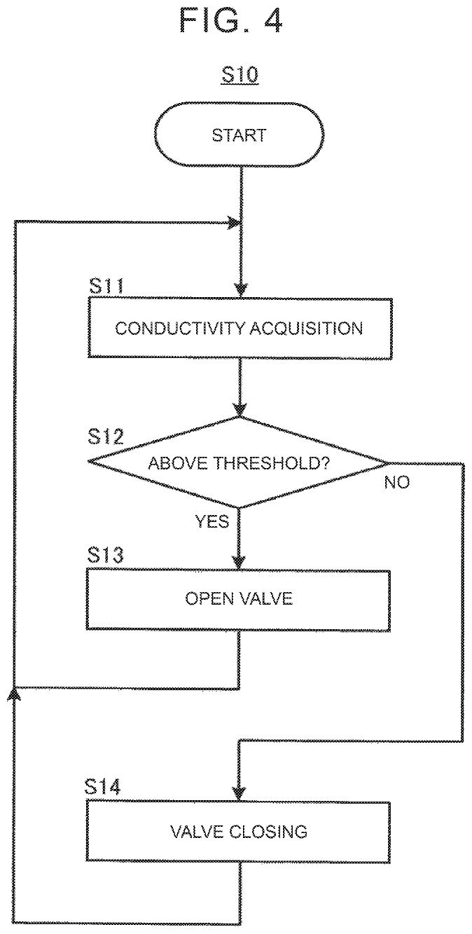

As shown in S10 in FIG. 4, the controller 30 obtains the conductivity from the conductivity meter 28 (S11), and determines whether the conductivity is greater than or equal to a predetermined threshold (e.g., 1 μS/m) (S12). When S12 is greater than or equal to the thresholds, it is determined to be Yes, and the valve 29 is opened and drained (S13), and the process returns to S11. On the other hand, when S12 is lower than the threshold, the valve 29 is turned No to close (S14), and S11 is returned. When the valve 29 is already in the closed state, the closed state is maintained.

Accordingly, it is possible to remove ions by discharging water having a high conductivity (including a large amount of ions) during the pipe flushing.

### 2.2. Stack Flushing

The stack flushing is a preparation step performed in a state where no voltage is applied to the water electrolysis stack 20, and is a step of flushing the flow path on the water supply side path and the water supply side path side of the water electrolysis stack.

In the stack flushing, water is circulated by the pump 22 in a state where the valve 27 is closed. Accordingly, the water circulates in the path of the pump 22, the cooler 23, the ion exchanger 24, the water electrolysis stack 20, the gas-liquid separator 25, and the tank 21. In this stack flushing, the controller 30 obtains the conductivity from the conductivity meter 28 (S11), as shown by way of S10 in FIG. 4, and determines whether the conductivity is greater than or equal to a predetermined threshold (e.g., 1 μS/m) (S12). When S12 is greater than or equal to the thresholds, it is determined to be Yes, and the valve 29 is opened and drained (S13), and the process returns to S11. On the other hand, when S12 is lower than the threshold, the valve 29 is turned No to close (S14), and S11 is returned. When the valve 29 is already in the closed state, the closed state is maintained.

Accordingly, it is possible to remove ions by discharging water having a high conductivity (including a large amount of ions) during stack flushing.

### 2.3. Stack Aging

Stack aging is a preparation step performed by applying a voltage to the water electrolysis stack 20, and is a step of adjusting conditions so that the water electrolysis stack 20 can perform water electrolysis as a steady operation.

In the stack aging, a voltage is applied to the water electrolysis stack 20, and water is circulated by the pump 22 in a state where the valve 27 is closed in the water supply side path. Accordingly, the water circulates in the path of the pump 22, the cooler 23, the ion exchanger 24, the water electrolysis stack 20, the gas-liquid separator 25, and the tank 21. In addition, in the hydrogen side path, the hydrogen and the accompanying water discharged from the water electrolysis stack 20 reach the gas-liquid separator 40, and the hydrogen and the water (the accompanying water) are separated. On the other hand, in the water recirculation path, water is returned from the gas-liquid separator 40 to the tank 21 by the pump 51.

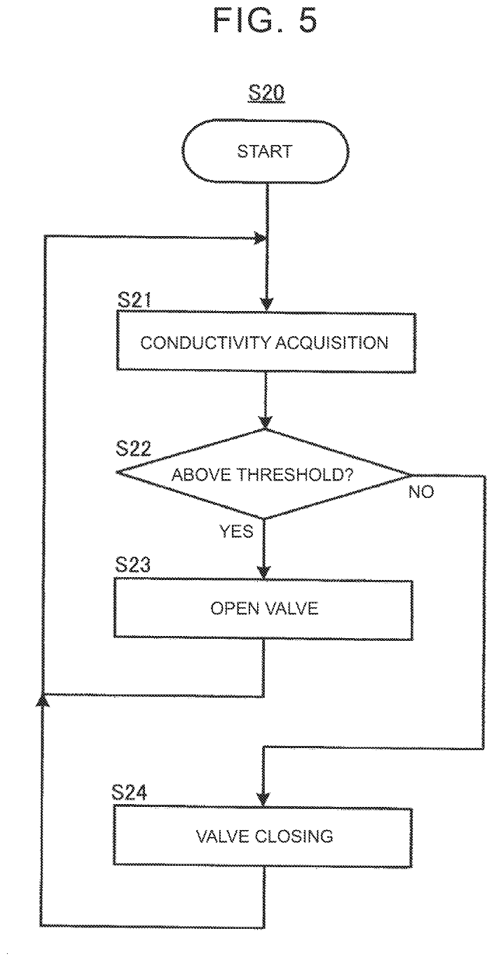

In the stack aging, the controller 30 obtains the conductivity from the conductivity meter 52 (S21), as shown in S20 in FIG. 5, and determines whether the conductivity is greater than or equal to a predetermined threshold (e.g., 1 μS/m) (S22). When S22 is greater than or equal to the thresholds, it is determined Yes, and the valve 53 is opened and drained (S23), and the process returns to S21. On the other hand, when S22 is lower than the threshold, the valve 53 is turned No to close (S24), and S21 is returned. When the valve 53 is already in the closed state, the closed state is maintained.

Accordingly, it is possible to remove ions by discharging water having a high conductivity (including a large amount of ions) during stack aging.

Here, when the valve 53 can adjust its discharge flow rate, it can be adjusted to discharge an amount of water equivalent to the associated amount of water. The associated water amount is calculated by the controller 30 as follows, for example.

First, the water consumption rate is calculated. The water flow rate [L/min] can be obtained from the following equation.

Electrolysis current [q/s]÷Faraday constant 96500 [q/mol]×0.5×18 [g/mol]×10⁻³ [L/mL]×number of water electrolysis cells×60 [sec/min]

Next, the consumed flow rate of the obtained water is multiplied by 4 to obtain the associated water amount [L/min].

### 2.4. Normal Operation in Water Electrolysis

The normal operation in the water electrolysis is a normal operation in which a voltage is applied to the water electrolysis stack 20 to obtain hydrogen.

In the normal operation, a voltage is applied to the water electrolysis stack 20, and water is circulated by the pump 22 in a state where the valve 27 is closed in the water supply side path. Accordingly, the water circulates in the path of the pump 22, the cooler 23, the ion exchanger 24, the water electrolysis stack 20, the gas-liquid separator 25, and the tank 21. In addition, in the hydrogen-side path, the hydrogen and the accompanying water discharged from the water electrolysis stack 20 reach the gas-liquid separator 40, and the hydrogen and the water (the accompanying water) are separated. On the other hand, in the water recirculation path, water is returned from the gas-liquid separator 40 to the tank 21 by the pump 51.

In the stack aging, the controller 30 obtains the conductivity from the conductivity meter 52 (S21), as shown in S20 in FIG. 5, and determines whether the conductivity is greater than or equal to a predetermined threshold (e.g., 1 μS/m) (S22). When S22 is greater than or equal to the thresholds, it is determined Yes, and the valve 53 is opened and drained (S23), and the process returns to S21. On the other hand, when S22 is lower than the threshold, the valve 53 is turned No to close (S24), and S21 is returned. When the valve 53 is already in the closed state, the closed state is maintained.

Accordingly, it is possible to remove ions by discharging water having a high conductivity (including a large amount of ions) during stack aging.

Here, when the valve 53 can adjust its discharge flow rate, it can be adjusted to discharge an amount of water equivalent to the associated amount of water. The associated water amount can be calculated by the controller 30, for example, as follows.

First, the water consumption rate is calculated. The water flow rate [L/min] can be obtained from the following equation.

Electrolysis current [q/s]÷Faraday constant 96500[q/mol]×0.5×18 [g/mol]×10⁻³ [L/mL]×number of water electrolysis cells×60 [sec/min]

Next, the consumed flow rate of the obtained water is multiplied by 4 to obtain the associated water amount [L/min].

### 3. Effects, Etc.

According to the water electrolysis apparatus 10 of the present embodiment, it is possible to more reliably suppress ions from being supplied to the water electrolysis stack 20 by control. At this time, since it is possible to remove ions without relying on the ion exchanger according to the present embodiment, it is possible to reduce the capacity even when installing the ion exchanger, or to reduce the frequency of replacement and maintenance.

In addition to the above-described embodiments, the insulation resistance of the water electrolysis stack may be measured and used instead of the conductivity meter. In addition, the conductivity can be lowered by grasping the water level of the gas-liquid separator in the hydrogen-side path by the water level sensor and draining the water in the hydrogen side path in the range of the water level held by the amount of water circulating in the water reduction path.

In order to reduce the elution of metal ions into the water in the hydrogen side path when the water electrolysis apparatus is stopped, the water in the hydrogen side path may be reduced while looking at the water level gauge of the gas-liquid separator in the hydrogen side path. This can reduce the stack aging time when the water electrolysis apparatus is restarted.

What is claimed is:

1. A water electrolysis apparatus that supplies water to a water electrolysis cell and applies a voltage to obtain hydrogen and oxygen, the water electrolysis apparatus comprising:
a water electrolysis stack in which the water electrolysis cells are laminated;
a water supply side path including a pipe through which water is supplied to the water electrolysis stack;
a hydrogen side path including a pipe through which hydrogen generated from the water electrolysis stack is recovered; and
a water recirculation path including a pipe through which water from the hydrogen side path is returned to the water supply side path, wherein:
in each of the water supply side path and the water recirculation path, a conductivity meter that measures conductivity of water flowing through the pipe, a valve from which water from the pipe is drained, and a controller are provided; and
the controller performs control to drain water from the valve based on a measured value of the conductivity meter.

2. The water electrolysis apparatus according to claim 1, wherein in the water electrolysis apparatus, the controller performs control using the conductivity meter and the valve provided in the water supply side path in an operation in which water electrolysis is not performed in the water electrolysis stack, and performs control using the conductivity meter and the valve provided in the water recirculation path in an operation in which water electrolysis is performed in the water electrolysis stack.

3. The water electrolysis apparatus according to claim 2, wherein in the operation in which the water electrolysis is performed in the water electrolysis stack, the controller acquires a water consumption flow rate due to the water electrolysis, calculates an accompanying water amount to the hydrogen side path, and determines an amount of the drained water based on the accompanying water amount.
